(19) United States
(12) Patent Application Publication
(10) Pub. No.: US 2007/0243419 A1
(43) Pub. Date: Oct. 18, 2007

(54) Edge profile of a magnetic recording tape

(75) Inventors: Siu-Yue Tam, Arden Hills, MN (US); William R. Qualls, River Falls, WI (US); Kerry D. Reimer, Hugo, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/403,284

(22) Filed: Apr. 12, 2006

(51) Int. Cl. G11B 5/706

(52) U.S. Cl. 428/845; 428/845.5

(57) ABSTRACT

Magnetic recording tapes include a substrate defining a front face, a back face, a first side, a second side opposite the first side, and a width between the first and second sides. The front face and first side define a first corner and the back face and first side define a second corner. One tape edge profile is typified by the first side not extending beyond the first and second corners, respectively. Another profile is typified by an Edge Abrasivity Depth Factor (EADF) from about 0 μm to about 0.8 μm. Yet another profile is typified by an Edge Abrasivity Volume Factor (EAVF) of about 4,800 μm³ or less.

### CROSS-REFERENCE TO RELATED APPLICATION

The present application is related to U.S. Pat. App. Ser. No. ______ TO BE AMENDED UPON DESIGNATION, entitled “MAGNETIC RECORDING TAPE EDGE PROCESSING,” referenced as 10532US01, filed on even date herewith, and the contents of which are incorporated herein by reference.

### THE FIELD OF THE INVENTION

The present invention generally relates to magnetic recording media. More particularly, the present invention relates to magnetic recording tape having optimized edge profiles.

### BACKGROUND OF THE INVENTION

Magnetic recording tape is used in a wide array of applications. Generally, magnetic recording tape employs particulate material such as ferromagnetic iron oxides, chromium oxides, ferromagnetic alloy powders and the like dispersed in binders and coated on a substrate. Typically, magnetic recording tapes comprise a front coat coated onto at least one surface of a non-magnetic substrate. In certain designs, the front coat is formed of a single layer directly onto the non-magnetic substrate. In an alternative approach, a dual layer front coat construction is employed, including a lower support layer coated onto the substrate and a thin recording layer coated onto the lower support layer. The two layers may be formed simultaneously or sequentially. The support layer is typically non-magnetic and generally comprised of a non-magnetic powder dispersed in the binder. Conversely, the recording layer comprises one or more metal particle powders or pigments dispersed in the binder system.

Magnetic tapes may also have a back coat coating applied to the opposing side of the non-magnetic substrate in order to improve the durability, electroconductivity, and tracking characteristics of the magnetic recording media. The back coat coatings are typically combined with a suitable solvent to create homogenous mixture which is then coated onto the substrate. The formulation for the back coat coating also comprises pigments in a binder system. Typical back coats include carbon black or other materials having particle sizes configured to form a smooth background with some larger particles dispersed therein to generally improve durability and frictional characteristics of the back coat during manufacturing and use.

The coated substrate is dried, calendered if desired, and cured. At some point, a full-width coated stock roll is cut down to final format width, for example, by slitting the coated stock roll into final format widths. During slitting, slit edges are formed on each side of the magnetic recording tape. Unfortunately, the resulting edges formed during slitting may lead to cracking, debris generation, wear on components coming into contact with the slit edges, and other problems.

### SUMMARY OF THE INVENTION

One aspect of the present invention relates to a magnetic recording tape including a substrate, a front coat, and a back coat. The substrate includes a non-conductive polymeric material. The substrate defines a front face, a back face opposite the front face, a thickness between the front face and the back face, a first side, a second side opposite the first side, and a width extending laterally between the first side and the second side. The front face and the first side define a first corner, the back face and the first side define a second corner, and the first side of the substrate has a maximum lateral extension in a direction opposite the second side that extends beyond the first and second corners, respectively. The front coat includes a magnetic component, the front coat being adhered to the front face of the substrate and not protruding laterally beyond the first corner of the substrate. The back coat is adhered to the back face of the substrate and does not protrude laterally beyond the second corner the substrate.

Another aspect of the present invention relates to a magnetic recording tape including a substrate and a front coat. The substrate includes a substantially non-abrasive material. The front coat is adapted for recording, the front coat formed over the substrate. The substrate and the front coat define a coated substrate having a thickness, a width, a first edge, and a second edge, the first edge extending laterally to the second edge to define the width of the coated substrate. The first edge is characterized by an Edge Abrasivity Depth Factor (EADF) of about 0.8 μm or less.

Yet another aspect of the present invention relates to a magnetic recording tape including a substrate and a front coat. The substrate is formed of a substantially non-abrasive material and defines a top surface, a bottom surface, a first side, and a second side. The front coat includes substantially abrasive particles and is maintained on the top surface of the substrate to define a coated substrate. The coated substrate has a width extending laterally between a first edge and second edge, the second edge opposite the first edge. The first edge is characterized by at least a portion of the first side of the substrate projecting laterally beyond the recording layer. The first edge is further characterized by an Edge Abrasivity Volume Factor (EAVF) of about 4,800 μm³ or less.

### BRIEF DESCRIPTION OF THE DRAWINGS

FIG. 1 is a general, cross-sectional view of an embodiment magnetic recording tape having a preferred edge profile, according to principles of the present invention.

FIG. 2 is a schematic view of an embodiment abrasivity test system, according to principles of the present invention.

FIG. 3 is a schematic view of a portion of the abrasivity test system of FIG. 2, according to principles of the present invention.

FIGS. 4A and 4B are SEM photographs of magnetic recording tape edges, according to principles of the present invention.

FIGS. 5A-5D are graphical representations of edge profiles of magnetic recording tape, according to principles of the present invention.

FIGS. 6A and 6B are graphical representations of edge profiles of magnetic recording tape, according to principles of the present invention.

### DETAILED DESCRIPTION

In the following detailed description, specific embodiments are described indicating examples of ways in which the invention may be practiced. It is to be understood that other embodiments may be utilized and structural or logical changes may be made without departing from the scope of the present invention. The following detailed description, therefore, describes certain embodiments of the invention and is not to be taken in a limiting sense. The scope of the present invention is defined by the appended claims.

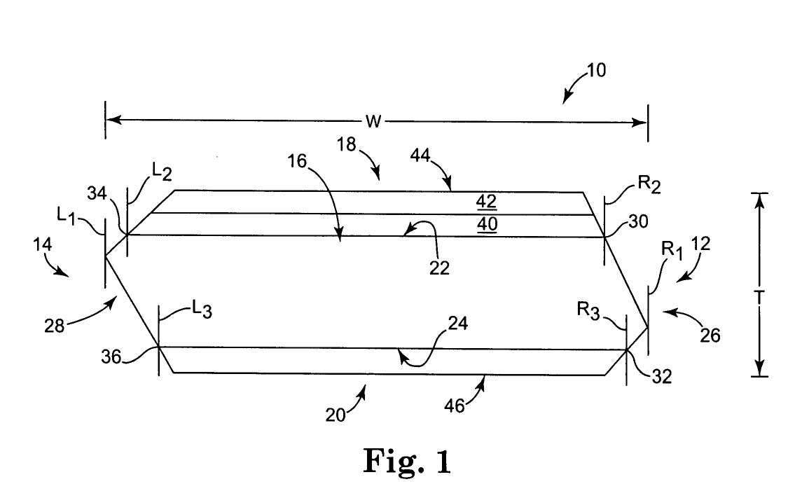

Turning to the figures, FIG. 1 illustrates a schematic, end view of a magnetic recording tape 10. The magnetic recording tape 10 has a length (not shown), a width W, and a thickness T. The magnetic recording tape 10 extends widthwise, or laterally, between a first edge 12 and a second edge 14 and generally includes a substrate 16, a front coat 18, and a back coat 20. As will be described in greater detail, the first and/or second edges 12, 14 of the magnetic recording tape 10 according to embodiments of the present invention generally have reduced abrasivity and/or propensity to generate debris during use as compared to conventional media.

The Substrate

The substrate 16 defines a top surface 22 and a bottom surface 24 opposite the top surface 22. The substrate 16 extends laterally from a first side 26 to a second side 28. The first side 26 and the top surface 22 of the substrate 16 define a first, top corner 30. In turn, the first side 26 and the bottom surface 20 of the substrate 16 define a second, bottom corner 32. Similarly, the second side 28 and the top and bottom surfaces 22, 24 define a third, top corner 34 and a fourth, bottom corner 36, respectively. In one embodiment, the substrate 16 tapers in thickness from each of the corners 30, 34 to the first side 26 and tapers in thickness from the each of the corners 32, 36, to the second side 28. For example, the tapers are optionally about 45 degrees.

Each of the first and second sides 26, 28 project laterally in opposite directions to the other. In particular, the substrate 16 defines a profile at the first side with a first side maximum lateral extension R₁ in a direction opposite the second side 28. In other words, the first side maximum lateral extension R₁ represents the “outermost” front of the substrate 16 at the first side 26. In turn, the substrate defines a second side maximum lateral extension L₁ in a direction opposite the first side 26. Once again, the second side maximum lateral extension L₁ represents the “outermost” front of the substrate 16 at the second side 28. Together, the first and second side maximum lateral extensions R₁, L₁ define the overall width of the substrate 16 as they are both the outermost fronts of the substrate 16. It should be noted that the maximum lateral extensions R₁, L₁ can be located anywhere along the first and second sides 26, 28 of the substrate 16, respectively, depending upon the profile of the substrate 16 at the first and second sides 26, 28. Regardless, the maximum lateral extensions R₁, L₁ are each measured in a direction substantially parallel to the top surface 22 of the substrate 16.

In one embodiment, the first and second sides 26, 28 each define a substantially convex transverse profile. For example, where the first side 26 has a substantially convex transverse profile, the maximum outward extension R₁ will be located at an apex, or maximum lateral protrusion of the substantially convex transverse profile. Regardless, the maximum outward extensions R₁, L₁ are located at the outermost protrusion of the substrate 16 by the first and second sides 26, 28, respectively.

In general, the substrate 16 is in elongated tape form or configured to be subsequently cut into elongated tape form, for example, in a slitting operation. The substrate 16 can be any conventional non-magnetic substrate useful as a magnetic recording tape support. Examples of substrate materials useful for the magnetic recording tape 10 include polyesters such as polyethylene terephthalate (PET), polyethylene naphthalate (PEN), a mixture of polyethylene terephthalate and polyethylene naphthalate; polyolefins (e.g., polypropylene), cellulose derivatives, polyamides, and polyimides. In one example, polyethylene terephthalate or polyethylene naphthalate is preferably employed as the substrate 16. The substrate 16 is optionally characterized as substantially non-abrasive, or substantially less abrasive than the front coat 18 and/or back coat 20.

The Front Coat

The front coat 18 generally extends over and is bonded to top surface 22 of the substrate 16. The front coat 18 is adapted for recording and is optionally formed as a dual layer or a single layer construction. In one embodiment, in which the front coat 18 is formed of dual layer construction, the front coat 18 includes a support layer 40 and a recording layer 42. The support layer 40 extends over and is bonded to the top surface 22 of the substrate 16. The recording layer 42 extends over and is bonded to the support layer 40. For reference, the terms “layer” and “coating” are used interchangeably herein in association with the front coat 18 and/or the back coat 20 to refer to a coated composition.

In other embodiments, the front coat 18 is formed as a single layer construction in which the support layer 40 is eliminated and the magnetic layer 42 is bonded directly to the substrate 16. Regardless, the front coat 18 is formed by a suitable combination of one or more layers that define a front face 44 opposite the substrate 16. In one embodiment, the front coat 18 has a coercivity of greater than 2000 Oerstads (Oe).

The front coat 18 optionally tapers in thickness from the front face 44 to the first and third corners 30, 34, respectively. The front coat 18 optionally tapers in thickness from the front face 44 toward the first and third corners 30, 34 at about 45 degrees, for example. Regardless, the front coat 18 defines a maximum lateral extension R₂ at the first edge 12 of the magnetic recording tape 10. The maximum lateral extension R₂ is measured in a direction opposite to the second edge 14 of the magnetic recording tape 10 and substantially parallel to the front face 44. In turn, the front coat 18 defines a maximum lateral extension L₂ at the second edge 14 of the magnetic recording tape 10. The maximum lateral extension L₂ is measured in a direction opposite the first edge 12 and substantially parallel to the front face 44.

The Support Layer

In one embodiment, the support layer 40 is essentially non-magnetic, for example, including a non-magnetic or soft magnetic component or powder and a resin binder system. As used herein, the term “soft magnetic powder” refers to a magnetic powder having a coercivity of less than about 300 Oe. By forming the support layer 40 to be essentially non-magnetic, the electromagnetic characteristics of the recording layer 42 are not substantially adversely affected. However, to the extent that no substantial adverse effect is caused, the support layer 40 may contain a small amount of magnetic powder. In one embodiment, the support layer 40 may also include at least one of a primary pigment material, conductive carbon black, an abrasive or head cleaning agent, a binder resin, a head cleaning agent binder, a service treatment agent, a lubricant, stearic acid, and/or solvents. The materials for the support layer 40 are mixed and the support layer 40 is subsequently coated on the top surface 22 of the substrate 16.

The Recording Layer

In one embodiment, the recording layer 42 includes a dispersion of a magnetic component such as magnetic pigments, an abrasive or head cleaning agent, a binder system, one or more lubricants, a conventional surfactant or wetting agent, and/or one or more solvents. The dispersion of magnetic pigments includes metallic iron and/or alloys of iron and is configured to provide a generally reliable and durable surface for recording and storing data. The materials for the recording layer 42 are mixed together and coated onto the support layer 40. In one embodiment, the recording layer 42 is applied to the support layer 40 in order to provide the front face 44 with properties configured to increase signal-to-noise ratios and to decrease error ratings for the magnetic recording tape 10.

The magnetic pigments have a composition including, but not limited to, metallic iron and/or alloys of iron with cobalt and/or nickel, and magnetic or non-magnetic oxides of iron, other elements, or mixtures thereof, which will hereinafter be referred to as metal particles. Alternatively, the metal particles can be composed of hexagonal ferrites such as barium ferrites. In one embodiment, the magnetic pigments are substantially abrasive.

“Coercivity” and “magnetic coercivity” are synonymous, are abbreviated Hc, and refer to the intensity of the magnetic field needed to reduce the magnetization of a ferromagnetic material (in this case the recording layer 42) to zero after the material has reached magnetic saturation. Use of metal particles with relatively high coercivity with a high volume of concentration within the recording layer 42 causes the magnetic recording tape 10 to exhibit a significantly narrowed pulsewidth, when measured by recording a signal on the magnetic recording tape 10 at a sufficiently low density that the transitions are isolated from one another (i.e., they do not interact or interfere with one another). In one embodiment, the magnetic pigment utilized in the magnetic recording tape has a coercivity greater than about 183 kA/m (23000e), preferably greater than about 191 kA/m (2400 Oe).

In order to improve the required characteristics, the preferred magnetic pigments may contain various additives, such as semi-metal or non-metal elements and their salts or oxides, such as Al, Co, Y, Ca, Mg, Mn, Na, and other suitable additives. The selected magnetic pigment may be treated with various auxiliary agents before it is dispersed in the binder system.

The head cleaning agent may be added to the recording layer dispersion separately or may be dispersed within a binder system prior to addition to the recording layer dispersion. In one embodiment, the head cleaning agent is aluminum oxide. Other abrasive grains, such as silica, ZrO₂, CrO₃, etc., can also be employed either alone or in mixtures with aluminum oxide or each other to form the head cleaning agent.

The binder system of the recording layer 42 incorporates at least one binder resin, such as a thermoplastic resin, in conjunction with other resin components, such as binders and surfactants used to disperse the head cleaning agent, a surfactant or wetting agent, and one or more hardeners. In one embodiment, the binder system of the recording layer 42 includes a combination of a primary polyurethane resin and a vinyl resin.

In one embodiment, the recording layer 42 includes one or more lubricants such as a fatty acid and/or a fatty acid ester. The incorporated lubricant(s) exist throughout the front coat 18 including at the front face 44 of the front coat 18. In general, the lubricant(s) reduce friction to maintain smooth contact with low drag and at least partially protects the front face 36 from wear. Thus, the lubricant(s) provided in both the recording layer 42 and the support layer 40 are selected and formulated in combination.

The materials for the recording layer 42 are mixed together to form the recording layer dispersion. The recording layer dispersion is coated onto the support layer 40 to form the recording layer 42. In one embodiment, solvents are added to the recording layer dispersion prior to coating the support layer 40 with the recording layer 42. For example, solvents associated with the recording layer 42 include cyclohexanone (CHO) with a concentration in the range of about 5% to about 50%, methyl ethyl ketone (MEK) with a concentration in the range of about 30% to about 90%, and toluene (Tol) with a concentration in the range of about 0% to about 40%. Other solvents or solvent combinations including, for example, xylene, tetrahydrofuran, methyl isobutyl ketone, and methyl amyl ketone, can also be utilized.

In one embodiment, the coated and processed recording layer 42 has a final thickness from about 0.05 μm to about 0.25 μm, preferably from about 0.5 μm to 0.125 μm. In one embodiment, the recording layer 42 is formed to have a remanent magnetization-thickness product (Mr*t) of less than about 2.5 memu/cm², preferably less than about 2.1 memu/cm². The term “remanent magnetization-thickness product” refers to the product of the remanent magnetization after saturation in a strong magnetic field (796 kA/m) multiplied by the thickness of the recording layer coating.

“Orientation Ratio” refers to the ratio of remanent magnetization at zero applied magnetic field after saturation in a strong magnetic field (796 kA/m) measured in the direction parallel to that of the recording medium's intended transport to the corresponding quantity measured in the direction transverse (i.e., perpendicular, but in the plane of the magnetic recording tape 10) to that of the intended transport of the magnetic recording tape 10. In one embodiment, the fully processed recording layer 42 has an orientation ratio of greater than 2.2, preferably greater than 2.4.

The Back Coat

The back coat 20 generally provides support for the magnetic recording tape 10. The back coat 20 generally extends under and is bonded to the bottom surface 24 of the substrate 16 and defines a back face 46 opposite the front face 44. In one embodiment, the back coat 20 tapers in thickness from the back face 46 to the second and fourth corners 32, 36, respectively. For example, the back coat 20 optionally tapers at an angle of about 45 degrees to the back face 46. Regardless, the back coat 20 defines a maximum lateral extension R₃ at the first edge 12 of the magnetic recording tape 10. The maximum lateral extension R₃ is measured in a direction opposite the second edge 14 of the magnetic recording tape 10 and substantially parallel to the back face 46. In turn, the back coat 20 defines a maximum lateral extension L₃ at the second edge 14 of the magnetic recording tape 10. The maximum lateral extension L₃ is measured in a direction opposite the first edge 12 and substantially parallel to the back face 46.

The back coat 20 is optionally configured to improve durability of the magnetic recording tape 10 as well as the amount of friction between the magnetic recording tape 10 and read/write mechanisms. The back coat 20 primarily consists of one or more magnetic or non-magnetic particles such as carbon black, alumina, silicon dioxide, titanium dioxide, and the like. The particles are dispersed as inks with appropriate binders, surfactants, ancillary particles forming a binder system, and solvents therefor. In one embodiment, the binder system includes at least one of a polyurethane resin and nitrocellulose blended appropriately to modify coating stiffness as desired.

In one embodiment, the back coat 20 comprises a combination of two kinds of carbon blacks, including a primary, small carbon black component and a secondary, large texture carbon black component, in combination with appropriate binder resins. In one example, the primary, small carbon black component has an average particle size on the order of from about 10 nm to about 25 nm, whereas the secondary, large carbon component has an average particle size on the order of from about 50 nm to about 300 nm. While the back coat 20 is optionally non-magnetic or not otherwise adapted for recording, in one embodiment, the back coat 20 includes one or more magnetic components and is adapted for recording.

As is known in the art, pigments of the back coat 20 are optionally dispersed as inks with appropriate binders, surfactant, ancillary particles, and solvents. In a preferred embodiment, a back coat binder includes at least one of the following: a polyurethane polymer, a phenoxy resin, or nitrocellulose added in an amount appropriate to modify coating stiffness as desired.

Manufacturing Process

In one embodiment utilizing a dual layer construction, manufacturing the support layer 40 includes combining each of the components of the support layer 40 in a manner described above to form a coating to be applied to the substrate 16. Similarly, each of the recording layer 42 and the back coat 20 is also optionally mixed to form the respective coating mixtures for subsequent addition to the magnetic recording tape 10.

The particular process for manufacturing the magnetic recording tape 10 optionally includes an in-line portion and one or more off-line portions. The in-line portion includes unwinding the substrate 16 or related material from a spool or supply. The substrate 16 is coated with the back coat 20 material on the bottom surface 24 of substrate 16, and the back coat 20 is dried, typically using conventional ovens. The front coat 18 is also applied to the substrate 16. In one embodiment employing a dual layer front coat 18, the support layer 40 is first applied directly to the substrate 16 and the recording layer 42 is then coated atop the support layer 40. Alternatively, the front coat 18 can be applied to the substrate 16 prior to application of the back coat 20. In one embodiment, the support layer 40, the recording layer 42, and back coat 20 are applied to the substrate 16 or each other using wet-on-wet, dual-slot, sequential dye, or other coating processes. In one embodiment employing a single layer front coat 18, the recording layer 42 is applied directly to the substrate 16.

The coated substrate 16, 18, 20 is magnetically orientated and dried, and then proceeds to an in-line calendering station. More specifically, the recording layer 42 is orientated by being advanced through one or more magnetic fields to generally align the magnetic orientation of the metal particles of the recording layer 42. In one example, each magnetic field is formed by electric coils and/or permanent magnets.

According to one embodiment, manufacturing of the magnetic recording tape 10 includes compliant-on-steel (COS), in-line calendering. COS in-line calendering uses one or more in-line nip stations, in each of which a steel or other generally non-compliant roller contacts or otherwise is applied to the front face 44 and a rubberized or other generally compliant roll contacts or otherwise is applied to the back face 46. The generally non-compliant roll is applied to provide a desired degree of smoothness to the magnetically coated side 18 of the substrate 16. In one embodiment, calendering further includes heating the rollers contacting the magnetic recording tape 10.

Alternatively or additionally, the in-line calendering includes “steel-on-steel” (SOS) calendering in which both opposing rolls are steel. The process may also employ one or more nip stations each having generally non-compliant rolls. After in-line calendering, the coated substrate 16, 18, 20 is wound. The process then proceeds to an off-line portion which occurs at a dedicated stand-alone machine. The magnetic recording tape 10 is unwound and calendered. The off-line calendering includes passing the magnetic recording tape 10 through a series of generally non-compliant rollers, e.g., multiple steel rollers, although other materials other than steel may be used to form the rollers. The magnetic recording tape 10 is then wound a second time. It should also be understood that calendering is optionally performed entirely off-line or on-line.

Regardless of a particular calendering method, or lack thereof, the wound roll of magnetic recording tape 10 is typically slit to a desired tape width, or final format width. In one embodiment, during slitting, one edge of the magnetic recording tape 10 is formed as a “supported edge,” while an opposing edge of the width of magnetic recording tape 10 is formed as an “unsupported edge.” For example, a slitter typically includes one or more knives, such as upper rotary blades, and one or more anvils, such as lower rotary blades. As understood by those of ordinary skill in the art, during slitting a portion of the magnetic recording tape 10 rests on an anvil with a knife cutting the magnetic recording tape 10 at an edge of the anvil. Where the magnetic recording tape 10 is cut, two edges are formed—one that corresponds to a portion of the magnetic recording tape 10 resting on the anvil, a “supported edge,” and an opposite edge corresponding to a portion of the magnetic recording tape 10 not supported by the anvil, an “unsupported edge.” Each length of magnetic recording tape 10 cut to final format width typically includes one supported edge, and one unsupported edge. For example, in one embodiment the first edge 12 of the magnetic recording tape 10 is formed as an unsupported edge while the second edge 14 of the magnetic recording tape 10 is formed as a supported edge, although any combination of supported/unsupported edges is contemplated. Furthermore, other methods of slitting or otherwise cutting the magnetic recording tape 10 to a desired width are contemplated.

Oftentimes, edges formed during slitting or other cutting operations are less than desirable with portions of the front coat 18 and/or portions of the back coat 20 are wider than the substrate 16 and project laterally beyond the substrate 16. Such projections may be problematic for several reasons. For example, the front coat 18 and the back coat 20 are often substantially brittle, with projections of the front coat 18 and/or back coat 20 easily breaking off from the magnetic recording tape 10. These broken off projections result in increased debris and can also result in reduced edge uniformity. Furthermore, it has been found that the slitting process can form small cracks in the relatively brittle coatings. In one example, the first edge 12 of the magnetic recording tape 10 can be formed as a supported edge, with the front coat 18 initially including cracking proximate the first edge. Such cracking further aggravates the potential for debris generation non-uniformity by weakening the particular coating at the edge and making it more susceptible to breaking off.

Additionally, such coating projections increase abrasiveness of the tape edges 12, 14 of the magnetic recording tape 10. Such abrasiveness results in wear on drive components and other surfaces coming into contact with the tape edges 12, 14. Not only do the front coat 18 and/or the back coat 20 include relatively abrasive components, the lateral projections often protrude beyond the substrate 16 to varying degrees with more prominent protrusions potentially catching on, breaking off, and/or digging into objects they contact. The more prominent protrusions can exaggerate abrasivity of the tape edges 12, 14, not only potentially further reducing component life, but also of further increasing debris generation when the projections break off.

In order to combat problems associated with coating projections, one embodiment includes implementing a method of edge processing as disclosed in U.S. Pat. App. Ser. No. ______ TO BE AMENDED UPON DESIGNATION, entitled “MAGNETIC RECORDING TAPE EDGE PROCESSING,” filed on even date herewith, and the contents of which are incorporated herein by reference (hereinafter “Tape Edge Processing”). In particular, the Tape Edge Processing method is optionally employed to reshape one or both of the edges 12, 14 to define a preferred edge profile. For example, the magnetic recording tape 10 is optionally abraded at the edges 12, 14 at forty-five degree angles to the front face 44 and the back face 46, respectively, and according to the method of Tape Edge Processing.

In one embodiment, a 15 μm grip lap film is used according to the Tape Edge Processing method. In addition to the ability to generate preferred edge profiles, an additional advantage of using the Tape Edge Processing methodology is increased uniformity along the tape edges 12, 14 and the absence of thermally-induced deformation proximate the first and second edges 12, 14 of the magnetic recording tape 10 that characterize other edge processing methods, e.g., methods of lasing tape edges with high and/or low intensity laser beams.

Preferred Edge Profile

As mentioned above, problems associated with edge abrasivity and debris generation are linked to coating projections, including the brittleness and/or abrasivity associated with such projecting portions of the front coat 18 and/or the back coat 20. The Tape Edge Processing method is one manner of reducing such problems by reshaping one or both of the first and second edges 12, 14 into a preferred edge profile.

With reference to FIG. 1, one embodiment preferred edge profile includes the maximum lateral extension R₂ of the front coat 18 being located at the first corner 30 of the substrate 16. In other words, the front coat 18 does not protrude, project, or extend laterally beyond the first corner 30 of the substrate 16. In one embodiment, and as shown generally in FIG. 1, the maximum lateral extension R₂ of the front coat 18 is laterally recessed relative to, or less than, the maximum lateral extension R₁ of the substrate 16. Alternatively, the maximum lateral extension R₂ of the front coat 18 is about the same as the maximum lateral extension R₁ of the substrate 16.

In turn, one embodiment preferred edge profile includes the maximum lateral extension L₂ of the front coat 18 being located at the third corner 34 of the substrate 16. In other words, the front coat 18 does not protrude, project, or extend laterally beyond the third corner 34 of the substrate 16. In one embodiment, and as shown generally in FIG. 1, the maximum lateral extension L₂ of the front coat 18 is laterally recessed relative to, or less than, the maximum lateral extension L₁ of the substrate 16. Alternatively, the maximum lateral extension L₂ of the front coat 18 is about the same as the maximum lateral extension L₁ of the substrate 16.

The back coat 20 is optionally shaped at the first edge 12 such that the maximum lateral extension R₃ of the back coat 20 is located at the second corner 32 of the substrate 16. In other words, the back coat 20 does not protrude, project, or extend laterally beyond the second corner 32 of the substrate 16. In one embodiment, and as shown generally in FIG. 1, the maximum lateral extension R₃ of the back coat 20 is laterally recessed relative to, or less than, the maximum lateral extension R₁ of the substrate 16. Alternatively, the maximum lateral extension R₃ of the back coat 20 is about the same as the maximum lateral extension R₁ of the substrate 16.

In turn, one embodiment preferred edge profile includes the maximum lateral extension L₃ of the back coat 20 being located at the fourth corner 36 of the substrate 16. In other words, the back coat 20 does not protrude, project, or extend laterally beyond the fourth corner 36 of the substrate 16. In one embodiment, and as shown generally in FIG. 1, the maximum lateral extension L₃ of the back coat 20 is laterally recessed relative to, or less than, the maximum lateral extension L₁ of the substrate 16. Alternatively, the maximum lateral extension L₃ of the back coat 20 is about the same as the maximum lateral extension L₁ of the substrate 16.

As shown in FIG. 1, the substrate 16 substantially projects, or juts outwardly relative to the front coat 18 and the back coat 20 such that the first and second sides 26, 28 of the substrate 16 can serve more effectively as bearing surfaces. In one embodiment, the maximum lateral extension R₁ of the substrate 16 extends in a direction opposite the second side 28 beyond the first and second corners 30, 32. For example, the maximum lateral extension R₁ optionally extends laterally about 1 μm or greater beyond both the first and second corners 30, 32. More preferably, the maximum lateral extension R₁ of the substrate 16 is greater than both the maximum lateral extensions R₂, R₃ of the front and back coats 18, 20. In this manner, the substrate 16 is more likely to contact an object coming into contact with the first edge 12 of the magnetic recording tape 10, thereby acting as a bearing surface, rather than the front or back coats 18, 20 coming into contact with the object and otherwise abrading against the object. For example, the maximum lateral extension R₁ is optionally about 1 μm or greater than both of the lateral extensions R₂, R₃ of the front and back coats 18, 20, respectively.

Similar concepts are optionally applied to the second edge 14. For example, the maximum lateral extension L₁ of the substrate 16 optionally extends in a direction opposite the first side 26 beyond each of the third and fourth corners 34, 36. For example, the maximum lateral extension L₁ optionally extends laterally about 1 μm or greater beyond both third and fourth corners 34, 36. More preferably, the maximum lateral extension L₁ of the substrate 16 is greater than both the maximum lateral extensions L₂, L₃ of the front and back coats 18, 20. As described above with reference to the first edge 12, the substrate 16 is more likely to contact an object coming into contact with the second edge 14 of the magnetic recording tape 10 to as a bearing surface, rather than the front or back coats 18, 20 coming into contact with the object. For example, the maximum lateral extension L₁ is optionally about 1 μm or greater than the lateral extensions L₂, L₃ of the front and back coats 18, 20, respectively.

Abrasivity

As previously described, a measure of the abrasiveness, or abrasivity, of the edges 12, 14 of the magnetic recording tape 10 relates to the likelihood of component wear and debris generation through abrasion. Additionally, edge abrasivity is related to an amount of coating protrusion. While the front coat 18 and/or back coat 20 are relatively abrasive in some embodiments, the substrate 16 is optionally formed of a relatively non-abrasive material in comparison. Thus, if the substrate 16 is contacted or otherwise allowed to act as the edge bearing surface rather than contacting portions of the front coat 18 or back coat 20 at the edges 12, 14, abrasivity of the edges 12, 14 is greatly reduced. As such, edge abrasivity can be used as an indicator of lateral coating protrusion beyond the substrate 16, and therefore whether the first and second edges 12, 14 of the length of magnetic recording tape 10 are typified by desired, or preferred, edge profiles including those embodiments described above.

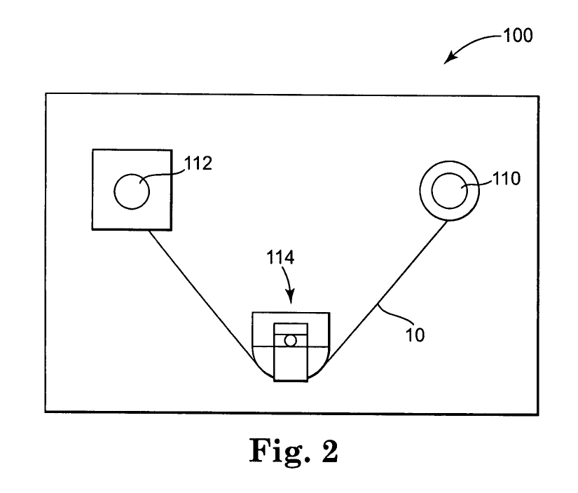

With reference to FIG. 2, an abrasivity test system 100 for determining Edge Abrasivity Factors (EAFs) for the magnetic recording tape 10 is described. The test system 100 includes a tape source 110 for feeding the tape 10, a tape winder 112 for receiving the tape 10, and an abrasivity test device 114. The magnetic recording tape 10 travels from the tape source 110 to the abrasivity test device 114, and from the abrasivity device 114 to the tape winder 112.

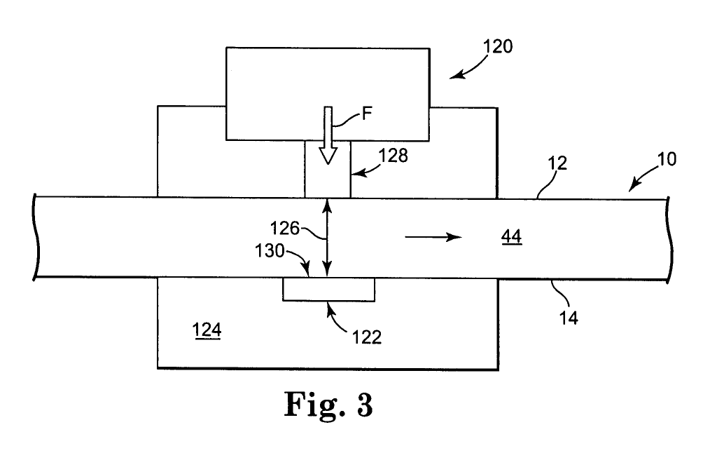

With reference to FIG. 3, the test device 114 includes a press 120, a test coupon 122, and a support surface 124. In general terms, the magnetic recording tape 10 travels over the support surface 124 with one of the front face 44 or the back face 46 facing the support surface 124. The magnetic recording tape 10 is pressed edgewise between the press 120 and the test coupon 122. The press 120 and the test coupon 122 define a gap 126 which is adjustable, such that the magnetic recording tape 10 can be clamped, or pressed, to varying extents. The abrasivity test system 100 includes a force measuring gauge (not shown) for measuring a force F exerted on the magnetic recording tape 10, and a resultant force exerted by the magnetic recording tape 10 on the test coupon 122.

The press 120 includes a press head 128. The press head 128 is adapted to slidably contact one of the first and second edges 12, 14 of the magnetic recording tape 10. The press head 128 is optionally formed of a relatively hard and/or low friction material to prevent wear. In one embodiment, the press head 128 is substantially cylindrical, although other shapes are also contemplated.

The test coupon 122 is formed of a relatively soft material, such as brass, and defines a test surface 130. In one embodiment, the test surface 130, or a portion thereof coming into contact with the magnetic recording tape 10, is substantially planar and is between about 600 μm and about 1100 μm in width, and more preferably about 1000 μm.

During testing the magnetic recording of tape 10 travels between the press head 128 and the test coupon 122 with one of the first or second edges 12, 14 sliding against the press head 128 and the other one of the edges 12, 14 sliding against the test surface 130 of the test coupon 122. A desired size of the gap 126 between the press head 128 and the test surface 130 is adjusted. Gap size is optionally selected according to the force F resulting from the press head 128 and the test coupon 122 coming into contact with the first and second tape edges 12, 14. In one embodiment, the force F is set at about 4 grams.

In view of the above assembly, a method of measuring Edge Abrasivity Factors is described as follows. The length of magnetic recording tape 10 is slid against the test surface 130 of the test coupon 122 by moving the length of tape 10 over the support surface 124 in the direction shown. The gap 126 between the press head 128 and the test surface 130 is selected as desired, for example, via a distance measurement and/or a force measurement. A score line is formed in the test surface 130 as the magnetic recording tape 10 scrapes, or abrades, the test surface 130. The score line defines a length and has a depth, a transverse area, and a volume, all of which are directly related to abrasiveness of the particular tape edge.

The test coupon 122 is then analyzed to determine dimensions of the score line. Transverse area, length, depth, and/or volume of the score line are optionally measured using an interferometer, for example, interferometers sold under the tradename WYKO® and associated analysis software available from WYKO® Co. of Tucson, Ariz., such as WYKO® Vision for RST Plus Version 1.8. The measured score line depth corresponds to an Edge Abrasivity Depth Factor (EADF). In turn, the measured volume of the score line corresponds to an Edge Abrasivity Volume Factor (EAVF). In view of the above, it should be apparent that the Edge Abrasivity Factors (EAFs) are descriptors of relative abrasivity of the first or second tape edges 12, 14.

In one embodiment, the Edge Abrasivity Depth Factor (EADF) of the tape 10 is from about 0 μm to about 0.8 μm. Preferably, the Edge Abrasivity Depth Factor (EADF) is from about 0 μm to about 0.6 μm. More preferably, the Edge Abrasivity Depth Factor (EADF) is about 0.2 μm or less. Even more preferably, the Edge Abrasivity Depth Factor (EADF) is about cum. It should also be understood that ranges and values implied by those specifically referenced above are also contemplated, such as from about 0.2 μm to about 0.6 μm or about 0.3 μm or less, for example.

In turn, the Edge Abrasivity Volume Factor (EAVF) of the tape 10 is from about 0 μm³ to about 4,800 μm³. Preferably, the Edge Abrasivity Volume Factor (EAVF) is about 3,200 μm³ or less. More preferably, the Edge Abrasivity Volume Factor (EAVF) is about 900 μm³ or less. Even more preferably, the Edge Abrasivity Volume Factor (EAVF) is about 0 μm³. It should also be understood that ranges and values implied by those specifically referenced above are also contemplated, such as from about 900 μm³ to about 4,800 μm³ or about 2,000 μm³ or less, for example.

### EXAMPLES

Objects and advantages of this invention are further illustrated by the following examples and comparative examples. The particular materials and amounts thereof recited in these examples, as well as other conditions and details, should not be construed to unduly limit the invention.

All data referred to as “Processed” relates to tape that underwent Tape Edge Processing according to the methods described in U.S. patent application Ser. No. ______ TO BE AMENDED UPON DESIGNATION, entitled “MAGNETIC RECORDING TAPE EDGE PROCESSING.” In particular, tape edges were abraded at about forty-five degree angle offsets to the top and bottom surfaces of the tape using 15 μm grit lap film. All tape was moved through two edge processing systems, one positioned to abrade the front coat and one positioned to abrade the back coat such that all four “corners” of the magnetic recording tape were abraded.

Edge abrasivity testing was performed on several cartridges of the magnetic recording tape. In particular, an abrasivity test system constructed according to the principles described above was used. A brass test coupon having a test surface width of 1.0 mm was used for each run. Each run was performed with an edge force of 4 g applied to each length of tape. Five runs of Unprocessed LTO Generation 3 (Linear Tape Open) cartridges of magnetic tape, available from Imation Corp. under the trade designation IMATION® LTO ULTRIUM® 3, were tested and five runs of Processed LTO Generation 3 cartridges of magnetic tape, available from Imation Corp. under the trade designation IMATION® LTO ULTRIUM® 3, were tested. Each run corresponds to a different length of tape maintained in a particular tape cartridge. The data from each run was acquired by passing the tape from the particular tape cartridge over the brass coupon in a first direction, then back over the coupon in a reverse direction for a total of six passes over the brass coupon (three in the first direction and three in the reverse direction). Thus, each score line corresponding to a “run” was formed by six passes of the particular length of tape over the coupon. For each run, a short length of tape proximate each of the ends attached to the tape source and the tape winder (about 30 cm at each end) was not passed over the coupon.

Data corresponding to slit edges of the lengths of tape was collected. In particular, an Edge Abrasivity Depth Factor (EADF) and an Edge Abrasivity Volume Factor (EAVF) were generated for tape edges of each of the lengths of tape from the cartridges. Representative data for averaged values for the Processed and Unprocessed tape and minimum values for the Processed and Unprocessed LTO ULTRIUM® Generation 3 tape is summarized below in Table 1.

TABLE 1

| Condition | EADF | EAVF |
|---|---|---|
| Processed | Average <1 μm | Average <4,500 μm³ |
| Processed | Min ≈0 μm | Min ≈0 μm |
| Processed | Max <4 μm | Max <20,000 |
| Unprocessed | Average >5 μm | Average ≧55,000 μm³ |
| Unprocessed | Minimum >0.9 μm | Min >4,800 μm³ |
| Unprocessed | Max >10 μm | Max >100,000 μm³ |

The values used for the summary presented in Table 1 are shown below in Table 2 with all values in micrometers (μm).

TABLE 2

| | Run 1 | Run 2 | Run 3 | Run 4 | Run 5 |
|---|---|---|---|---|---|
| EAVF | | | | | |
| Unprocessed | 89091 | 32643 | 4868 | 104339 | 64786 |
| Processed | 18121 | 4080 | 0 | 0 | 0 |
| EADF | | | | | |
| Unprocessed | 4.29 | 4.20 | 0.91 | 10.60 | 7.87 |
| Processed | 3.67 | 0.92 | 0 | 0 | 0 |

Additional testing of other LTO ULTRIUM® tapes from various sources all exhibited minimum Edge Abrasivity Depth Factors (EADFs) greater than about 0.9 μm and minimum Edge Abrasivity Volume Factors (EAVFS) greater than about 4,800 μm³.

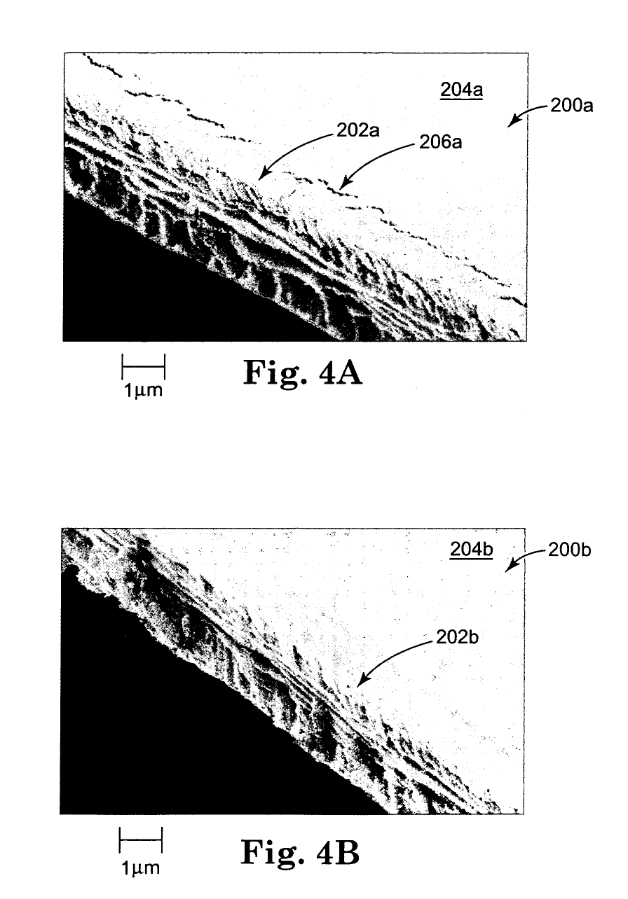

In addition to edge abrasivity testing, SEM images revealed a drastic reduction in edge cracking following Tape Edge Processing. In particular, SEM images were taken of Unprocessed and Processed LTO Generation 3 cartridges of magnetic tape, available from Imation Corp. under the trade designation IMATION® LTO ULTRIUM® 3. For example, FIG. 4A is a SEM image illustrating Unprocessed LTO Generation 3 tape 200a having an edge 202a formed as a supported edge during slitting. A front coat 204a of the tape 200a is typified by a jagged line of cracking 206a proximate the edge 202a. In turn, FIG. 4B is a SEM image of Processed LTO Generation 3 tape 200b. The tape 200b includes an edge 202b formed as a supported edge during slitting. A front coat 204b of the tape is typified by a substantial reduction of edge cracking relative to the line of cracking 206a (FIG. 4A) within about 2 μm of the edge 202b and substantially eliminated such edge cracking within about 1 Sum of the edge 202b.

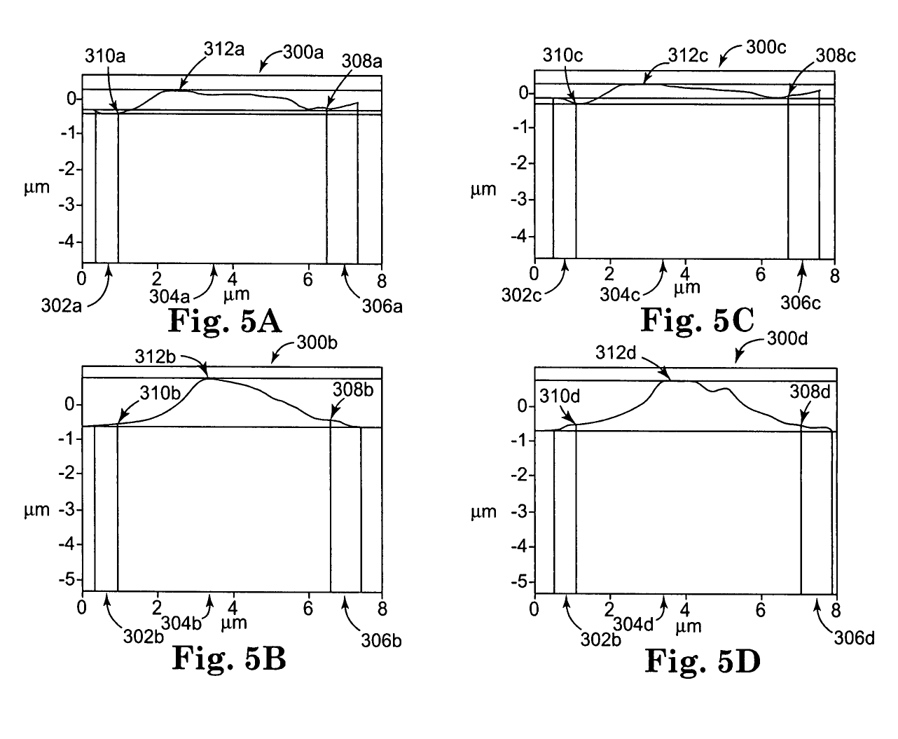

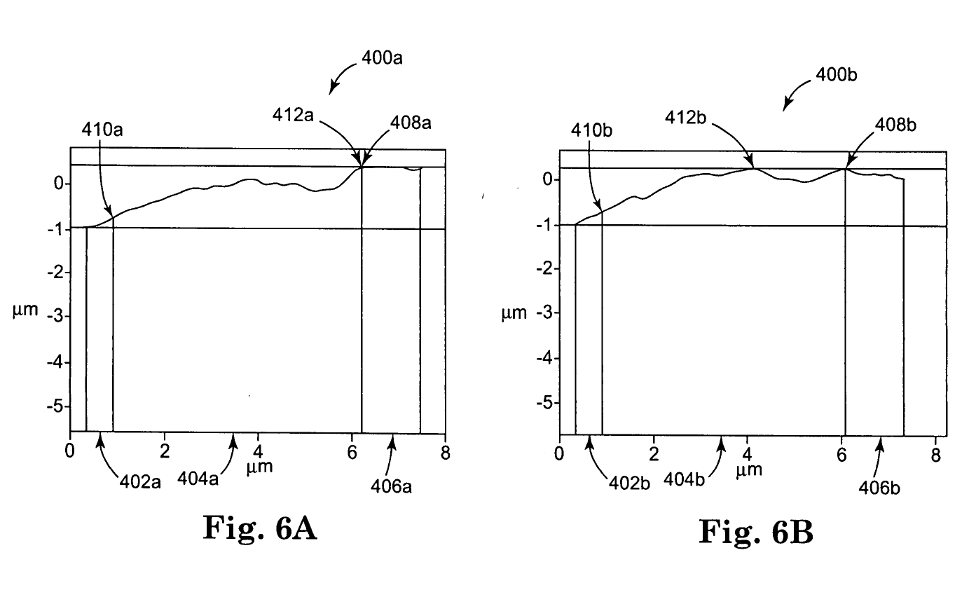

In addition to edge abrasivity testing and SEM images, laser profilometer data was taken to graph measured lateral extensions of the substrate, back coat, and front coats of several lengths of tape. In particular, profilometer readings were taken of Unprocessed and Processed LTO Generation 3 cartridges of magnetic tape, available from Imation Corp. under the trade designation IMATION® LTO ULTRIUM® 3, using a laser profilometer sold under the tradename WYKO® available from WYKO® Co. of Tucson, Ariz. FIGS. 5A-6B depict the data in graphical form.

FIGS. 5A and 5B show profiles of supported edges of an Unprocessed first tape 300a (FIG. 5A) and a Processed second tape 300b (FIG. 5B). FIGS. 5C and 5D show profiles of unsupported edges of an Unprocessed third tape 300c (FIG. 5C) and a Processed fourth tape 300d (FIG. 5D). In the figures, thicknesses of the substrates, front coats, and back coats are measured along the horizontal axis, while a relative amount of protrusion, i.e., lateral extension or lateral protrusion, is measured positively along the vertical axis.

With reference to FIG. 5A, the Unprocessed first tape 300a (supported edge) includes a back coat 302a, a substrate 304a, and a front coat 306a. The substrate 304a defines a first corner 308a and a second corner 310a. The front coat 306a protrudes laterally (measured positively on the vertical axis) beyond the first corner 308a and the back coat portion 302a protrudes laterally beyond the second corner 310a of the substrate 304a. Furthermore, a maximum lateral extension 312a (measured positively on the vertical axis) of the substrate 304a is less than 1 μm beyond the maximum lateral projections of both the back coat 302a and the front coat 306a.

With reference to FIG. 5B, the Processed second tape 300b (supported edge) includes a back coat 302b, a substrate 304b, and a front coat 306b. The substrate 304b defines a first corner 308b and a second corner 310b. The front coat 306b does not protrude, or project laterally beyond the first corner 308b, and in fact tapers in thickness (measured on the horizontal axis) to the first corner 302b. The back coat 302b does not project laterally beyond the second corner 310b, and in fact tapers in thickness to the second corner 310b. Furthermore, the substrate 304b defines a maximum lateral extension 312b that projects more than 1 μm relative to the maximum lateral extensions of both of the back coat 302a and the front coat 306a. Additionally, the lateral projection of the substrate 304b defines a substantially convex shape, with the tape 300b overall defining a substantially bell-shaped lateral profile overall.

With reference to FIG. 5C, the Unprocessed third tape 300c (unsupported edge) includes a back coat 302c, a substrate 304c, and a front coat 306c. The substrate 304c defines a first corner 308c and a second corner 310c. The front coat 306c projects laterally beyond the first corner 308c and the back coat 302c projects laterally beyond the second corner 310c of the substrate 304c. Furthermore, a maximum lateral extension 312a of the substrate 304c is less than 1 μm beyond the maximum projections of both the back coat 302c and the front coat 306c.

With reference to FIG. 5D, the Processed fourth tape 300d (unsupported edge) includes a back coat 302d, a substrate 304d, and a front coat 306d. The substrate 304d defines a first corner 308d and a second corner 310d. The front coat 306d does not project laterally beyond the first corner 308d, and in fact tapers in thickness to the first corner 302d of the substrate 304d. The back coat 302d does not project laterally beyond the second corner 310d, and in fact tapers in thickness to the second corner 310d of the substrate 304d. Furthermore, the substrate 304d defines a maximum lateral extension 312d that projects more than 1 μm beyond maximum projections of both of the back coat 302d and the front coat 306d. Additionally, the substrate 304d extends laterally along the vertical axis to define a substantially convex shape, with the fourth tape 300d projecting laterally to define a substantially bell-shaped lateral profile overall.

FIGS. 6A and 6B show edge profiles of unsupported edges of an Unprocessed first tape 400a (FIG. 6A) and a Processed second tape 400b (FIG. 6B). Once again, in FIGS. 6A and 6B, thicknesses of the substrates, front coats, and back coats are measured along the horizontal axis, while relative amounts of lateral extension or protrusion are measured positively along the vertical axis.

With reference to FIG. 6A, the Unprocessed first tape 400a (supported edge) includes a back coat 402a, a substrate 404a, and a front coat 406a. The substrate 404a defines a first corner 408a and a second corner 410a. The front coat 406a projects laterally (measured positively on the vertical axis) beyond the first corner 408a and the back coat 402a does not project laterally beyond the second corner 410a. A maximum lateral extension of the front coat 406a (measured positively on the vertical axis) is about equal to a maximum lateral extension 412a of the substrate 404a.

With reference to FIG. 6B, the Processed second tape 400b includes a back coat 402b, a substrate 404b, and a front coat 406b. The substrate 404b defines a first corner 408b and a second corner 410b. The front coat 406b does not project laterally beyond the first corner 408b and tapers in thickness toward the first corner 408b of the substrate 404b. The back coat 402b does not project laterally beyond the second corner 410b and tapers in thickness (measured on the horizontal axis) to the second corner 410b. Furthermore, the substrate 404b defines a maximum lateral extension 412b that projects laterally more than the maximum projections of both of the back coat portion 402a and the front coat portion 406a.

Although specific embodiments have been illustrated and described herein, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A magnetic recording tape comprising:
a substrate comprising a non-conductive polymeric material, the substrate defining a front face, a back face opposite the front face, a thickness between the front face and the back face, a first side, a second side opposite the first side, and a width extending laterally between the first side and the second side, wherein the front face and the first side define a first corner, the back face and the first side define a second corner, and the first side of the substrate has a maximum lateral extension in a direction opposite the second side that extends beyond the first and second corners, respectively;
a front coat comprising a magnetic component, the front coat being adhered to the front face of the substrate and not protruding laterally beyond the first corner of the substrate; and
a back coat adhered to the back face of the substrate, the back coat not protruding laterally beyond the second corner of the substrate.

2. The magnetic recording tape of claim 1, wherein the substrate, the front coat, and the back coat combine to define a coated substrate having a first edge and a second edge, the first edge having been formed as a supported edge in a slitting operation.

3. The magnetic recording tape of claim 1, wherein the substrate, the front coat, and the back coat combine to define a coated substrate having a first edge and a second edge opposite the first edge, the first edge having been formed as an unsupported edge in a slitting operation.

4. The magnetic recording tape of claim 1, wherein the substrate, the front coat, and the back coat combine to define a coated substrate having a first edge and a second edge opposite the first edge, the first edge typified by an Edge Abrasivity Depth Factor (EADF) of about 0.8 μm or less.

5. The magnetic recording tape of claim 1, wherein the substrate, the front coat, and the back coat combine to define a coated substrate having a first edge and a second edge opposite the first edge, wherein the first edge is typified by Edge Abrasivity Volume Factor (EAVF) of about 4,800 μm³ or less.

6. The magnetic recording tape of claim 1, wherein the substrate defines a maximum lateral extension, the maximum lateral extension typified as extending laterally beyond both the front coat and the back coat by at least about 1 μm.

7. The magnetic recording tape of claim 1, wherein the second edge of the substrate and the front face of the substrate define a third corner, wherein the second edge of the substrate and the back face of the substrate define a fourth corner, and further wherein the magnetic recording tape is typified by the front coat not protruding laterally beyond the third corner, the back coat not protruding laterally beyond the fourth corner, and the second edge of the substrate having a maximum lateral extension extending beyond both the third and fourth corners, respectively.

8. The magnetic recording tape of claim 1, wherein the magnetic component of the front coat is characterized by a coercivity of at least about 2,000 Oe.

9. The magnetic recording tape of claim 1, wherein the front coat and the back coat are substantially free of thermally-induced deformation proximate the first and second edges of the substrate.

10. The magnetic recording tape of claim 1, wherein the front coat, the back coat, and the substrate combine to define a coated substrate having a first edge and a second edge, the second edge opposite the first edge, wherein the first edge projects laterally opposite the second edge to define a substantially bell-shaped profile.

11. The magnetic recording tape of claim 1, wherein the substrate projects laterally opposite the second side to define a substantially convex profile at the first side.

12. A magnetic recording tape comprising:
a substrate including a substantially non-abrasive material; and
a front coat adapted for recording, the front coat formed over the substrate;
wherein the substrate and the front coat define a coated substrate having a thickness, a width, a first edge, and a second edge, the first edge extending laterally to the second edge to define the width of the coated substrate, and further wherein the first edge is characterized by an Edge Abrasivity Depth Factor (EADF) of about 0.8 μm or less.

13. The magnetic recording tape of claim 12, wherein the first edge is characterized by an Edge Abrasivity Depth Factor (EADF) of about 0.2 μm or less.

14. The magnetic recording tape of claim 12, wherein the first edge is characterized by an Edge Abrasivity Depth Factor (EADF) of about 0 μm.

15. The magnetic recording tape of claim 12, wherein the first edge of the coated substrate comprises a top corner of the substrate proximate the front coat and a bottom corner of the substrate opposite the top corner, and further wherein the front coat does not project laterally beyond the top corner of the substrate in a direction opposite the second edge.

16. The magnetic recording tape of claim 15, wherein the first edge is characterized by the substrate defining a maximum lateral extension of the coated substrate in a direction opposite the second edge of the coated substrate.

17. A magnetic recording tape comprising:
a substrate formed of a substantially non-abrasive material, the substrate defining a top surface, a bottom surface, a first side, and a second side; and
a front coat comprising substantially abrasive particles, the front coat maintained on the top surface of the substrate to define a coated substrate, the coated substrate having a width extending laterally between a first edge and second edge, the second edge opposite the first edge;
wherein the first edge is characterized by at least a portion of the first side of the substrate projecting laterally beyond the recording layer, and wherein the first edge is further characterized by an Edge Abrasivity Volume Factor (EAVF) of about 4,800 μm³ or less.

18. The magnetic recording tape of claim 17, wherein the first edge is characterized by an Edge Abrasivity Volume Factor (EAVF) of about 900 μm³ or less.

19. The magnetic recording tape of claim 17, wherein the first edge is characterized by an Edge Abrasivity Volume Factor (EAVF) of about 0 μm³.

20. The magnetic recording tape of claim 17, further comprising:
a back layer comprising substantially abrasive particles, the back layer maintained on the bottom surface of the substrate to define the coated substrate, wherein the first edge is further characterized by at least a portion of the substrate projecting laterally beyond the back layer in a direction opposite the second edge.
